(19) United States
(12) Patent Application Publication
(10) Pub. No.: US 2024/0359966 A1
(43) Pub. Date: Oct. 31, 2024

(54) Riding Saddle

(71) Applicant: Hammersmith Nominees Pty Ltd, West Perth (AU)

(72) Inventor: Ronald Gordon Bates, West Perth (AU)

(21) Appl. No.: 18/648,271

(22) Filed: Apr. 26, 2024

(30) Foreign Application Priority Data
Apr. 28, 2023 (AU) 2023901251

(51) Int. Cl. B68C 1/04

(52) U.S. Cl. CPC B68C 1/04

(57) ABSTRACT

A frame assembly for a riding saddle, comprising a base that provides a seat for a rider and a support member that is fitted thereto for supporting the rider, with the base including a pair of flexible arms that are couplable to a brace sized to fit the withers of an animal, and with the support member including a deformable element forward of the seat that extends upwardly between the arms, wherein a width of the arms is adjustable to conform to the animal by coupling the brace thereto.

### TECHNICAL FIELD

The invention relates to a frame assembly for a riding saddle, in particular to a frame assembly that is adjustable to conform to the animal, and to a riding saddle comprising said frame assembly.

### BACKGROUND

Animal saddles, in particular horse saddles, have a long history of use, dating back to around 800 BCE. The basic construction of a saddle has remained relatively unchanged over time, comprising an underlying base structure, known within the industry as a tree, with the tree being lined and covered by layers of leather and other cushioning material. Whilst the saddle tree was traditionally made from wood, in more recent times, the use of polymeric and other composite materials has become generally accepted.

Over time, two predominant styles of saddle emerged and have remained popular—the American or “Western” saddle and the English saddle (including its counterpart the Australian “Stock” saddle that evolved from it)—each with their own advantages and drawbacks.

The American or “Western” saddle is the dominant saddle across the Americas, and is identifiable by a prominent central swell and horn that extends upwardly from a front part of the saddle. The horn serves as a handle for supporting the rider within the saddle. Western saddles have a generally simple structure that whilst hardwearing and practical, provide limited means for adjustment and are therefore not overly comfortable for animal or rider.

By contrast, “Stock” and English saddles are the most popular saddles across Europe and Australia, and are identifiable by their “poley”—i.e. “hornless”—design. With particular reference to the Australian Stock saddle, knee pads are provided in place of the horn, with the rider supporting themselves within the saddle by bearing their legs against the knee pads. Whilst providing a higher level of adjustability to conform the saddle to the animal for improved rider and animal comfort, both Australian and English saddles lack the signature “cowboy” aesthetic of Western saddles as characterized by the raised swell and horn.

Against this backdrop, there is an emerging market for a “Hybrid” saddle that provides the adjustability and riding position of the Stock and English saddles with the look and feel of the Western saddle. To date, existing attempts at providing a Hybrid saddle have been unsuccessful, due at least in part to an inability to replicate the visual aesthetic and functional rider support provided by the swell and horn of a Western saddle, without compromising on the adjustability of an Australian or English saddle.

The present invention seeks to at least in part alleviate the above-identified problems, or to offer saddlers and riders with a useful alternative. The present invention was conceived with these short-comings in mind.

### SUMMARY

In a first aspect, the invention provides a frame assembly for a riding saddle, comprising a base that provides a seat for a rider and a support member that is fitted thereto for supporting the rider, with the base including a pair of flexible arms that are couplable to a brace sized to fit the withers of an animal, and with the support member including a deformable element forward of the seat that extends upwardly between the arms, wherein a width of the arms is adjustable to conform to the animal by coupling the brace thereto.

The base may include a bridge that extends between the arms, with the deformable element of the support member extending from the bridge to increase a height thereof. A lip may extend at least partly around a perimeter of the bridge, with the deformable element of the support member being received against the lip.

In some embodiments, the support member further includes a pair of side elements that extend outwardly from the arms, with the side elements being arranged to bear against a knee of the rider. The side elements of the support member may extend from the deformable element that is arranged therebetween. Optionally, the side elements may be attached to the base and at least partially overlay the deformable element, that the forward portion being held in position with respect to the base by the side elements. The side elements may be substantially rigid.

The side elements may comprise a mounting surface that is configured to rest upon the base and a bearing surface that extends substantially perpendicular therefrom, the bearing surface projecting outwardly from a side body of the animal. The base may include at least one depression, with the mounting surface of each side element being received and located in position upon the base by the at least one depression.

In some embodiments, the frame assembly may further comprise a cover that is attached to the base and extends over the support member such that the support member and the base have a substantially unitary appearance. Alternatively or additionally, the frame assembly may comprise a lining that is attachable to an underside of the base for bearing against a back of the animal, with the brace being sandwiched therebetween.

The deformable element of the support member may be formed of a foam material. The base may be formed from a polymeric material. The polymeric material may be polyurethane or a polymeric composite that includes polyurethane.

In a second aspect, the invention provides a riding saddle that incorporates the frame assembly as described herein.

In a third aspect, the invention provides a modular riding saddle, comprising: a frame assembly comprising a base having a seat for a rider and a support member that is fitted thereto and includes a raised deformable element forward of the seat for supporting the rider; and a brace that is couplable to the base of the frame assembly, the brace being selected to fit the withers of an animal; wherein, when the brace is coupled to the base, a width of the frame assembly adjusts to conform to the animal.

The support member may further include a pair of side elements, with the side elements being removable from the base. The modular riding saddle may further comprise a plurality of braces that are interchangeably couplable to the base, with each of the braces being of differing size.

In a fourth aspect, the invention provides a method of preparing a riding saddle, comprising the steps of: providing a base having a seat for a rider; and fitting a support member to the base, the support member including a raised deformable element disposed forward of the seat for supporting the rider; and coupling a brace to the base, the brace being sized to fit the withers of an animal, to adjust a width of the base to conform to the animal.

The support member further includes a pair of side elements, with the step of fitting the support member to the base comprising attaching the side elements to the base, with the raised deformable element being at least partly held in position with respect to the base by the side elements. The method may further comprise the step of: selecting the brace from one of a plurality of braces of different sizes that are interchangeably couplable to the base to provide an optimal fit.

### BRIEF DESCRIPTION OF THE DRAWINGS

The invention will now be described, by way of non-limiting example only, with reference to the accompanying drawings, in which:

FIG. 1 is a side view of a riding saddle according to an embodiment of the present invention, the riding saddle including an adjustable frame assembly comprising a base and a support member that is fitted thereto;

FIG. 2 is an underside view of the riding saddle;

FIG. 3 is a front view of the riding saddle;

FIG. 4 is a rear view of the riding saddle;

FIG. 5 is a side view of the base;

FIG. 6 is a front view of the base;

FIG. 7 is a side view of a central element of the support member;

FIG. 8 is an underside view of the central element of the support member;

FIG. 9 is a side view showing the central element of the support member fitted to the base;

FIG. 10 is a top view showing the central element of the support member fitted to the base;

FIG. 11 is a side view of a side element of the support member;

FIG. 12 is a front view of the side element of the support member;

FIG. 13 is a front view showing the side elements of the support member fitted to the base;

FIG. 14 is a side view showing the side elements of the support member fitted to the base;

FIG. 15 is a bottom view showing a selected brace coupled to an underside of the frame assembly; and

FIG. 16 is a perspective view showing a plurality of braces that are selectably couplable to the frame assembly;

FIGS. 17 to 20 illustrate a method of preparing the riding saddle of FIG. 1.

### DETAILED DESCRIPTION

In the following detailed description, reference is made to accompanying drawings which form a part of the detailed description. It will be readily understood that the aspects of the present disclosure, as generally described herein and illustrated in the drawings may be arranged, substituted, combined, separated and designed in a wide variety of different configurations, all of which are contemplated in this disclosure.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the example methods and materials are described herein.

In general terms, the riding saddle 10 shown in the Figures includes a frame assembly 12 that comprises a base 14 and a support member 16 that together form a saddle tree of the saddle. The base 14 provides a seat 18 for a rider, while the support member 16 is fitted to the base 14 and serves as a support that assists the rider to remain seated within the saddle 10. The support member 16 includes a central element 20 that projects upwardly in front of the rider. The riding saddle 10 also includes a brace 22 that is couplable to the base 14 of the frame assembly 12. The brace 22 has a size that is selected to fit across the withers of an animal to which the saddle is to be fastened. The brace 22 is coupled to the base 14, a width of the frame assembly 12 adjusts to conform to the animal. Notably, the support member 16 is configured to not inhibit this adjustment. Accordingly, it is understood that by providing a frame assembly 12 that is conformable to a particular animal, the riding saddle 10 provides improved levels of comfort to rider and animal.

The saddle described herein is a “hybrid” style riding saddle, combining the visual aesthetic of a “Western” type saddle with the adjustability and comfort for rider and animal alike of a “Stock” saddle. This is achieved, at least in part, by the provision of a frame assembly that comprises a flexible base member and a separate support member that is fitted thereto, with the support member including a deformable element that forms a distinctive swell forward of the rider, without inhibiting the ability of the frame assembly to be adjusted to suit different animals.

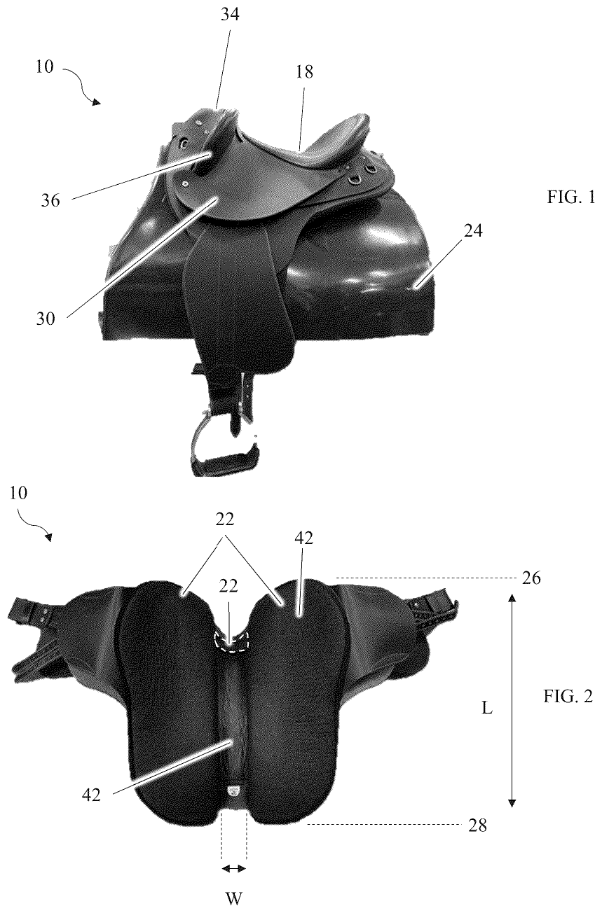

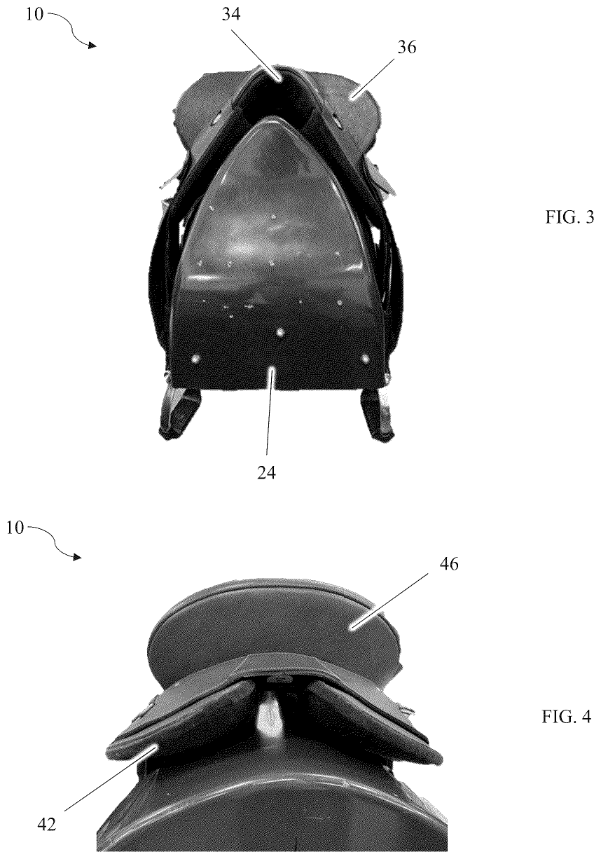

With reference to the embodiment shown in FIGS. 1 to 4, the riding saddle 10 is a horse saddle, and will be described herein with reference to use with a horse. It is understood, however, that the riding saddle 10 is also suitable for use with other animals, for example bulls, camels, donkeys, oxen and the like.

Turning first to FIGS. 1 to 4, where the riding saddle 10 is shown in-situ fastened to a stand 24 that approximates the body of a horse.

The saddle 10 extends between a front or proximal end 26 that is designed to rest upon the withers of the horse and a rear or distal end 28 that rests upon the back and loin of the horse. The seat 18 of the saddle 10 is disposed towards the rear end 28.

A pair of forward panels 30 extend outwardly from the front end 26 of the saddle 10, and are adapted to rest against the withers of the horse. The panels 30 are spaced apart by a channel or tunnel 32. The channel 32 defines a width of the saddle 10, being the distance between the panels 30. The brace or gullet plate 22 extends across the channel 32, to set and hold the panels 30 in a spaced relationship.

The front end 26 of the saddle 10 is marked by a swell or pommel 34. The swell 34 is a raised section disposed in front of the rider, having the shape of an inverted U that projects upwardly and across a width of the front end 26 of the saddle 10. The swell 34 assists in supporting the rider within the seat 18, providing a raised portion which can assist in resisting forward movement of the rider. The swell 34 provides the saddle 10 with a visual appearance that is substantially similar to a “Western” style saddle. Whilst not shown, it is contemplated that the swell 38 may also provide a base for a horn. The horn may be used to assist in supporting the rider within the seat 18 of the saddle.

The rider is further supported within the seat 18 by knee pads 36. The knee pads 36 are disposed towards the front end 26 of the saddle, forward of the seat 18. The knee pads 36 project outwardly from the sides of the saddle. When fastened to an animal, the knee pads 36 rest against a side body of the animal, flanking the spine on either side. The knee pads 36 provide a bearing surface 36 for contacting the rider. Whilst referred to as “knee” pads, it is understood that the knee pads 36 as shown do not bear against the knees of the rider. Rather, the knee pads 36 are arranged on a higher part of the saddle 10, flanking the swell 34. In this arrangement, the knee pads 36 bear against the upper leg of the rider. Such position is traditionally associated with the Australian “Stock” saddle and provides improved rider security. As shown in FIG. 4, the knee pads have complementary geometries that combine together to provide a panel-like bearing surface 38 that extends across the back of the animal, projecting from an upper surface of the saddle 10. In other embodiments, however, it is understood that the knee pads 36 may be spaced apart from one another and not form a combined panel, and/or may be arranged in a lower position upon panels 30, in a more conventional “English” saddle style. Further, it is also contemplated that in other embodiments of the saddle 10, the knee pads 36 may be omitted altogether in the style of a “Western” saddle.

The swell 34 and knee pads 36 are enclosed within a cover 40 that extends substantially over the entire saddle 10. The cover 40 provides a substantially unitary or smooth appearance to the saddle 10, with the frame assembly 12 or saddle tree being concealed underneath. The cover 40 may comprise several interconnected cover sections, including sections that are removable in order to provide access to and/or facilitate adjustment of the frame assembly 12. As shown, the cover 40 is formed from leather, and is therefore particularly durable and weatherproof. Other materials, for example synthetic leather, are also suitable.

A lining 42 may be provided along an underside of the saddle 10. The lining 42 serves as a padding element, resting between the animal and the remainder of the saddle 10 to improve rider and animal comfort. Preferably, the lining is made from a wool felt. Other suitable shock absorbing materials such as synthetic felt, sheep wool and foams are also contemplated.

Components of the saddle 10 will now be described in detail with reference to the corresponding Figures.

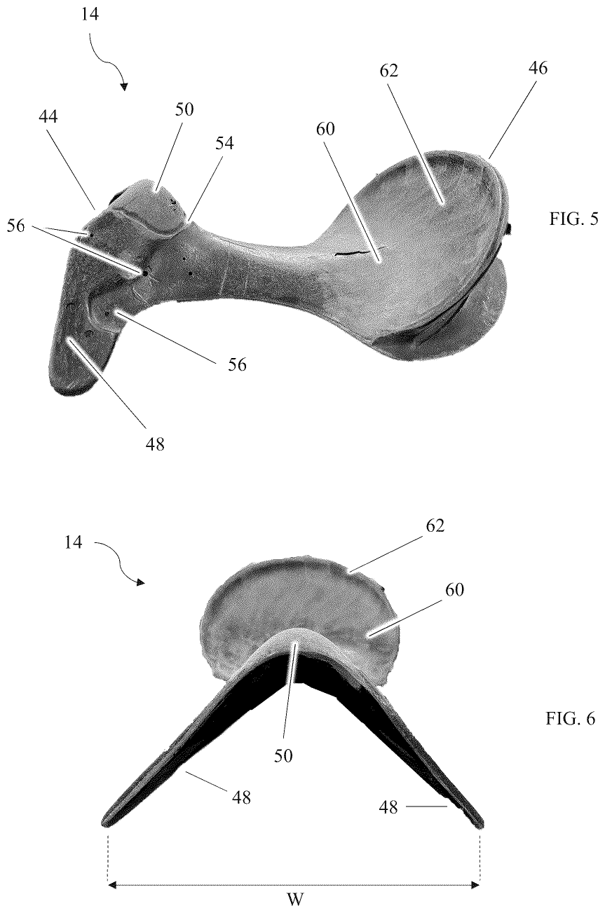

Turning first to FIGS. 5 and 6, which show the underlying base 14 of the frame assembly 12.

The base 14 is a structural element, serving as a chassis of the saddle 10. The base 14 is made from a polymeric material that is lightweight yet resilient to provide sufficient structural integrity to the saddle 10 whilst retaining a degree of flexibility. Suitable polymeric materials include ABS, nylon, polyethylene, polyoxymethylene, polypropylene, polyurethane, polyvinyl chloride, and/or blends thereof. Further, non-polymeric materials such fiber reinforced composites are also contemplated.

The base 14 includes a forward portion 44 and a rearward portion 46 that extends there behind. The forward portion 44 comprises a pair of arms 48. The arms 46 are spaced apart from one another by a bridge 50, giving the forward portion the shape of an inverted V when viewed from the front. Together, the arms 48 and bridge 50 provide structure to the panels 30.

The forward portion 44 of the base 14 is resilient, with the arms 48 are flexible arms. Specifically, each arm 48 includes mounting holes 52 for receiving fasteners (not shown). The fasteners are used to couple the brace or gullet plate 22 thereto. Flexing of the arms 48 permits a widening or narrowing of the width W of the forward portion 44 (depending on the size of brace 22 coupled thereto), so as to conform the base 14 to the withers of an animal to which the saddle 10 is to be fitted. This is advantageous, for it allows the fit of the saddle 10 to be customized to provide an optimal fit which improves rider and animal comfort. While this adjustability is a characteristic of “Stock” saddles, hitherto it has not been possible to provide such level of adjustability with a saddle having a prominent raised swell 34, due to the swell 34 inhibiting the ability of the underlying frame assembly to flex.

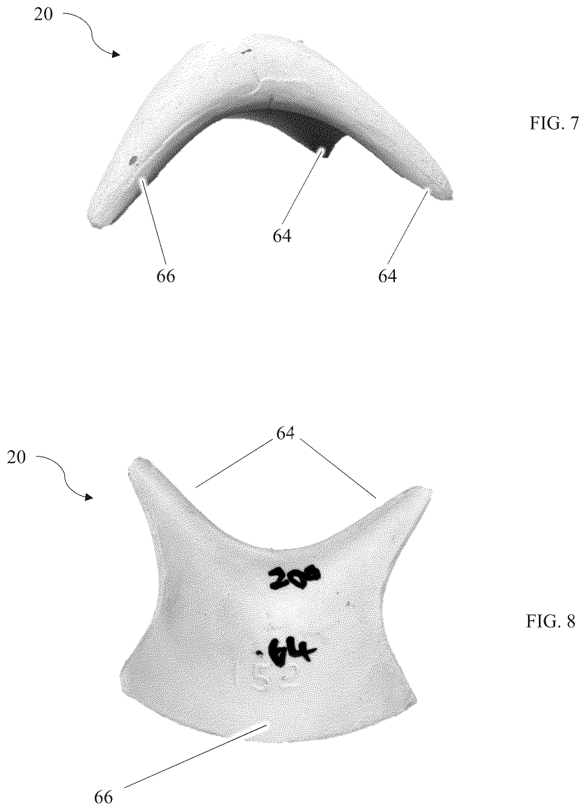

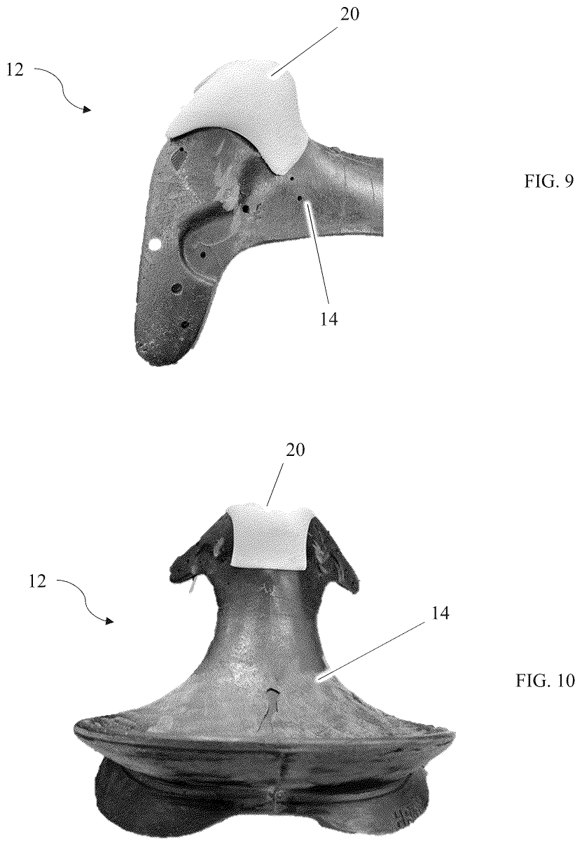

Designated mounting regions 52 are included within the forward portion 44 of the base 14 for receiving the support member 16. In particular, a lip 54 extends at least partly a perimeter of the bridge 50. The lip 54 defines a receiving region within which the central element 20 (shown in FIGS. 7 and 8) of the support member 16 is received. In addition, depressions 56 that extend at least partly along the arms 48 define receiving regions for side elements 58 (shown in FIGS. 9 and 10) of the support member 16.

The rearward portion 46 of the base 14 provides the seat 18 for the rider. In particular, a bowl shaped recess 60 is contoured to receive the rider and thereby providing a pan for the seat 18, with a raised cantle 62 extends upwardly from the recess 60 to support a lower back of the rider.

Moving now to FIGS. 7 to 10, which show the central element 20 of the support member 14.

The central element 20 is a deformable element, preferably formed from polyurethane or another suitable soft foam material. The central element 20 is generally star shaped, comprising a pair of substantially triangular front legs 64 and a curved rear skirt 66. The legs 62 and skirt 66 extend inwardly to form a concentric peak.

The central element 20 serves as a “cap” for the bridge 50, resting atop the bridge and therefore increasing a height thereof, to thereby produce the pronounced swell 34 of the saddle 10. As shown in FIGS. 9 and 10, the legs 64 are shaped to conform with the arms 48 of the base 14, while the skirt 66 is adapted to engage with the lip 54 of the receiving region of the bridge 50, to assist in positioning and locating the central element 20 atop the base 14. What is meant by “deformable” is that the central element 20 is malleable, so as not to inhibit the flexibility of the base 14 when fitted thereto, or to otherwise lessen the ability of the assembly 12 from adjusting to conform with natural contours of the horse's body. This is an important feature of the saddle 10, with the malleability of the central element 20 that is provided separate from and fitted to the underlying base 12 providing the saddle 10 with a raised swell portion 34 characteristic of a “Western” style saddle without inhibiting or otherwise impeding the ability of the frame 12 to be adjusted to conform to the animal.

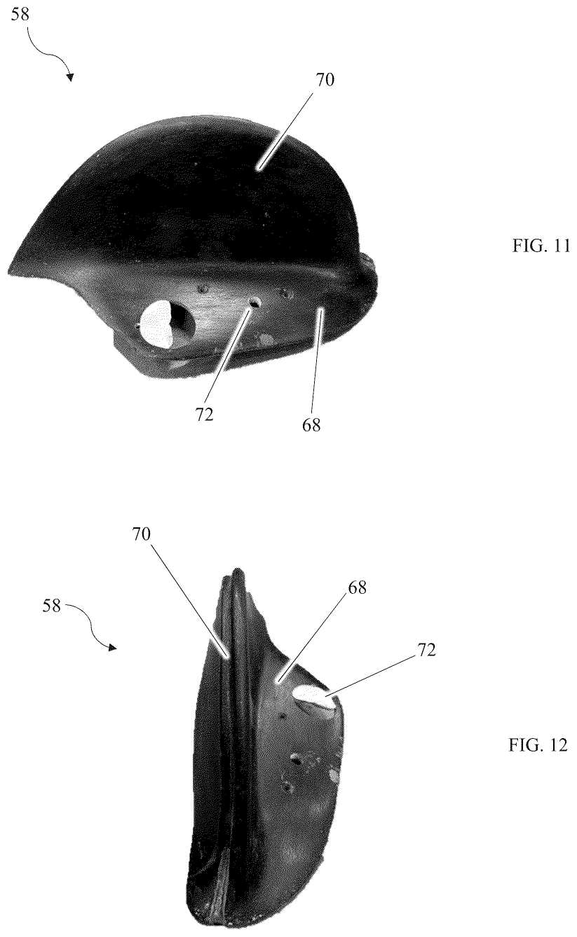

Turning now to FIGS. 11 to 14, which show the side elements 58 of the support member 14.

The side elements 58 are formed of a substantially rigid material, so as to provide suitable support to the legs of the rider. The side elements 58 have an “L” shaped profile, comprising a mounting surface 68 that is configured to be received within depressions 56 of the arms 48, and a shell shaped bearing surface 70 that extends substantially perpendicular therefrom. In particular, the mounting surface 68 of the side elements 58 include a plurality of mounting holes 72, with fasteners being inserted through mounting holes 72 and corresponding holes 52 of the base 14 to attach the side elements 58 to the base 14.

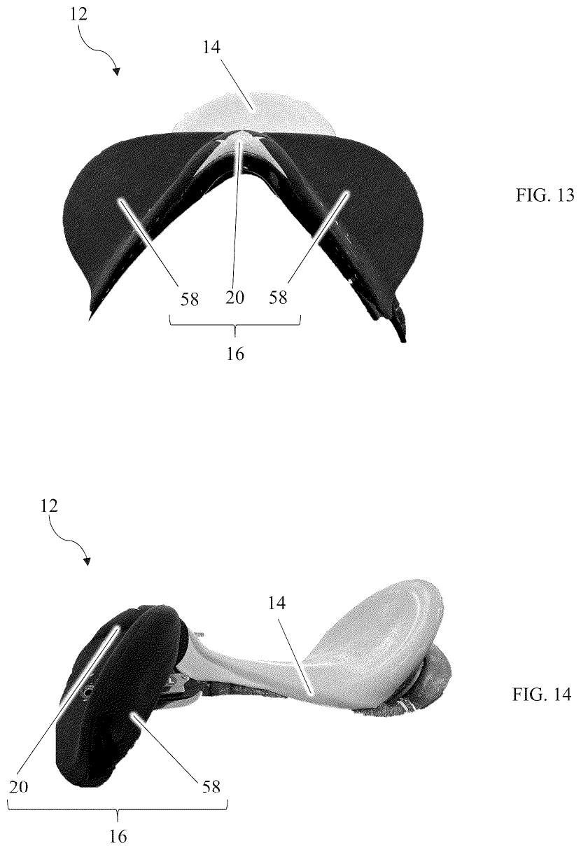

Best shown in FIGS. 13 and 14, the side elements 58 are arranged in abutment on either side of the central element 20. In particular, the bearing surface 70 of the side elements 58 extend behind the central element 20, thereby providing the panel like bearing surface 38 of the saddle. Meanwhile, at least part of the mounting surface 68 overlays the central element 20, to thereby secure the central element 20 in place atop the base 14. It is understood, however, that adhesives may also be used to provide additional securement of central element 20 to the base 14. It is contemplated that the rigidity of the side elements 58 (compared to the deformable central element 20) may provide a foundation for a horn to be mounted thereto, should the user seek to do so.

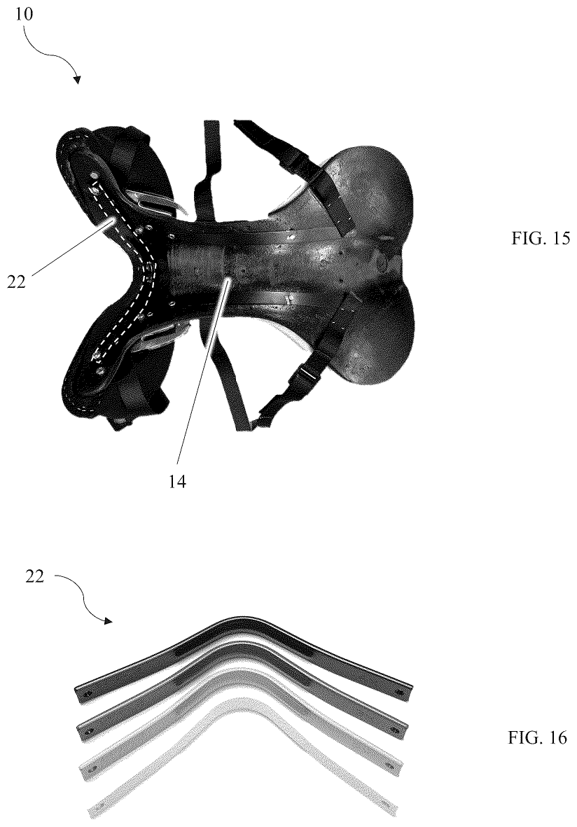

FIG. 15 shows a brace member 22 coupled to an underside of the frame assembly 12. As shown, the brace 22 is a gullet plate, being an elongate strip that is bent into an arch shape. The brace 22 is generally V shaped to conform to the withers of a horse. Apertures 74 are provided at opposing ends of the brace 22 for fastening the brace to the frame assembly via mounting holes 52. As previously discussed, the flexibility of the forward portion of the 44 of the base 14 and the malleability of the central element 20 provide a saddle tree having a pliability that allows for a width thereof to be set based on the size of brace 22 coupled thereto. As a result of this benefit, an optimal fit of saddle 10 on the horse is able to be obtained.

The brace 22 may be one of a plurality of braces, with each brace 22 being of a different size, to suit different widths of horse withers. Accordingly, it is understood that the fit of the saddle can be changed overtime, by interchanging the brace 22 for one of a different size—without requiring substitution of the frame assembly or other saddle components. This is particularly advantageous for riders of younger horses, which may be growing and thus require adjustment to the saddle to ensure optimal rider and animal comfort. In this way, it is understood that the riding saddle 10 is considered a modular riding saddle. The modular riding saddle may be provided in the form of a kit 76, with the kit 76 comprising the frame assembly 12 and at least one brace 22. Preferably, the kit 76 includes a plurality of different sized braces 22, such that a rider can customize the fit of their saddle 10 to suit the particular animal.

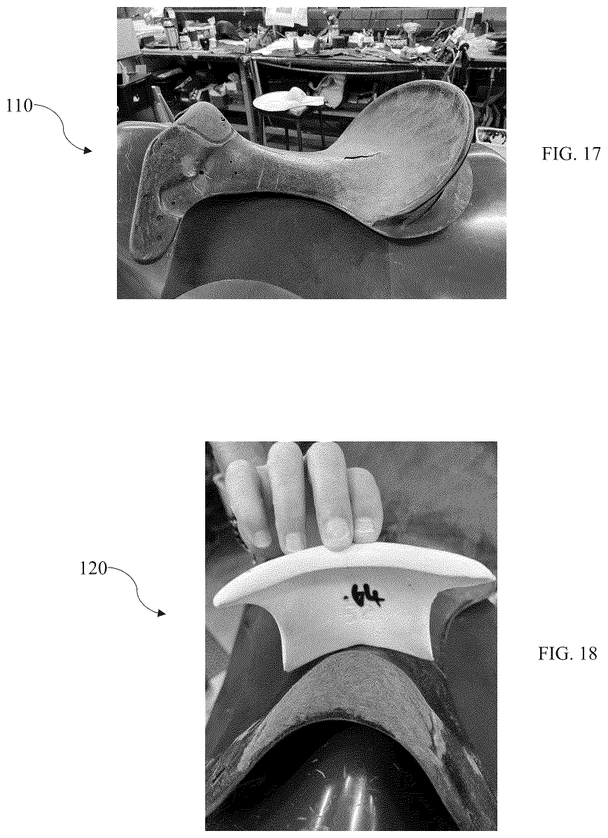

A method 100 of preparing the riding saddle 10 as described herein will now be described, with particular reference to FIGS. 17 to 20.

As represented in FIG. 18, during an initial or providing step 110, the base 14 of the saddle 10 is provided. The base 14 provides the seat 18 for the rider, and forms part of the frame assembly 12 or saddle tree.

The central element 20 is then fitted to the base 14 in a further or fitting step 120, shown in FIG. 18. As shown, the central element 20 is first positioned above the bridge 50 of the base 14, forward of the seat 18. The central element 20 is then located in position atop the bridge 50, with the skirt 64 resting against the lip 54.

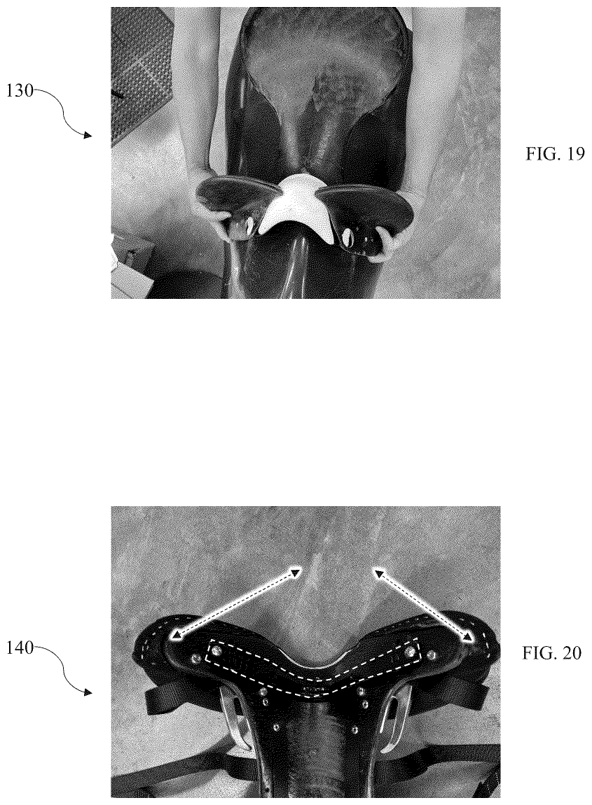

In a further or attaching step 130, subsequent to the central element 20 being fitted to the base 14, the side elements 58 are attached thereto. In particular, the mounting surfaces 68 are located within the depressions 56 of the base 14, at least partly overlaying the central element 20 that is disposed therebetween. In this way, attachment of the side elements 58 to the base 14 also serves as a means of securing the central element 20 thereto. This step is shown in FIG. 19.

In a further step 140, a brace element 22 is selected from a plurality of brace elements 22, with each of the brace elements being of different size. The selected brace element 22 is chosen to suit the withers of the horse to which the saddle is to be fitted.

In a further step 150, the selected brace element 22 is coupled to the base 14. During this step, the width of the base 14 is adjusted, with the arms of the base element being drawn apart or drawn together by the act of coupling the base thereto, as indicated by the dashed arrows of FIG. 20.

Summarily, it is understood that the saddle described herein allows coupling of different sized braces to the underlying frame assembly, with the frame assembly being adapted to flex inwardly and outwardly in order accommodate different size braces, selected to follow the natural contours of the withers of the animal to which the saddle is to be fitted. In particular, the same saddle can be fitted to animals having comparatively broad or narrow shoulders, simply by changing the brace that is fitted to the underlying frame assembly. In this manner, the saddle may be considered as a modular saddle that is able to be customized and/or adjusted to provide optimal fit to different animals without requiring significant adjustment or alteration to the saddle itself.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### LEGEND

| | |
|---|---|
| 10 | Saddle |
| 12 | Frame Assembly |
| 14 | Base |
| 16 | Support Member |
| 18 | Seat |
| 20 | Central Element |
| 22 | Brace |
| 24 | Stand |
| 26 | Front End |
| 28 | Back End |
| 30 | Forward Panels |
| 32 | Channel |
| 34 | Swell |
| 36 | Knee Pads |
| 38 | Bearing Surface |
| 40 | Cover |
| 42 | Lining |
| 44 | Forward Portion |
| 46 | Rearward Portion |
| 48 | Arms |
| 50 | Bridge |
| 52 | Mounting Holes |
| 54 | Lip |
| 56 | Depression |
| 58 | Side Element |
| 60 | Recess |
| 62 | Cantle |
| 64 | Legs |
| 66 | Skirt |
| 68 | Mounting Surface |
| 70 | Bearing Surface |
| 72 | Mounting Holes |
| 74 | Apertures |
| 76 | Kit |
| 100 | Method |
| 110 | Providing Step |
| 120 | Fitting Step |
| 130 | Attaching Step |
| 140 | Selecting Step |
| 150 | Coupling Step |

1. A frame assembly for a riding saddle, comprising a base that provides a seat for a rider and a support member that is fitted thereto for supporting the rider, with the base including a pair of flexible arms that are couplable to a brace sized to fit the withers of an animal, and with the support member including a deformable element forward of the seat that extends upwardly between the arms, wherein a width of the arms is adjustable to conform to the animal by coupling the brace thereto.

2. The frame assembly of claim 1, wherein the base includes a bridge that extends between the arms, with the deformable element of the support member extending from the bridge to increase a height thereof.

3. The frame assembly of claim 2, wherein the base includes a lip that extends at least partly around a perimeter of the bridge, with the deformable element of the support member being received against the lip.

4. The frame assembly of claim 1, wherein the support member further includes a pair of side elements that extend outwardly from the arms, with the side elements being arranged to bear against upper legs of the rider.

5. The frame assembly of claim 4, wherein the side elements of the support member extend from the deformable element that is arranged therebetween.

6. The frame assembly of claim 4, wherein the side elements are attached to the base and at least partially overlay the deformable element, that the forward portion being held in position with respect to the base by the side elements.

7. The frame assembly of claim 4, wherein the side elements are substantially rigid.

8. The frame assembly of claim 4, wherein the side elements comprise a mounting surface that is configured to rest upon the base and a bearing surface that extends substantially perpendicular therefrom, the bearing surface projecting outwardly from a side body of the animal.

9. The frame assembly of claim 8, wherein the base includes at least one depression, with the mounting surface of each side element being received and located in position upon the base by the at least one depression.

10. The frame assembly of claim 1, further comprising a cover that is attached to the base and extends over the support member such that the support member and the base have a substantially unitary appearance.

11. The frame assembly of claim 1, further comprising a lining that is attachable to an underside of the base for bearing against a back of the animal, with the brace being sandwiched therebetween.

12. The frame assembly of claim 1, wherein the deformable element of the support member is formed of a foam material.

13. The frame assembly of claim 1, wherein the base is formed from a polymeric material.

14. A riding saddle incorporating the frame assembly of claim 1.

15. A modular riding saddle, comprising:
a frame assembly comprising a base having a seat for a rider and a support member that is fitted thereto and includes a raised deformable element forward of the seat for supporting the rider; and
a brace that is couplable to the base of the frame assembly, the brace being selected to fit the withers of an animal;
wherein, when the brace is coupled to the base, a width of the frame assembly adjusts to conform to the animal.

16. The modular riding saddle of claim 15, wherein the support member further includes a pair of side elements, with the side elements being removable from the base.

17. The modular riding saddle of claim 15, comprising a plurality of braces that are interchangeably couplable to the base, with each of the braces being of differing size.

18. A method of preparing a riding saddle, comprising the steps of:
providing a base having a seat for a rider; and
fitting a support member to the base, the support member including a raised deformable element disposed forward of the seat for supporting the rider; and
coupling a brace to the base, the brace being sized to fit the withers of an animal, to adjust a width of the base to conform to the animal.

19. The method of claim 18, wherein the support member further includes a pair of side elements, with the step of fitting the support member to the base comprising attaching the side elements to the base, with the raised deformable element being at least partly held in position with respect to the base by the side elements.

20. The method of claim 18, further comprising the step of:
selecting the brace from one of a plurality of braces of different sizes that are interchangeably couplable to the base.
